(19) United States
(12) Patent Application Publication
(10) Pub. No.: US 2007/0209414 A1
(43) Pub. Date: Sep. 13, 2007

(54) Lock assembly for a sliding window or a sliding door

(76) Inventors: Christopher Bentley, Plymouth, MI (US); Gerald Majeske, Plymouth, MI (US)

Correspondence Address: REISING, ETHINGTON, BARNES, KISSELLE, P.C., P O BOX 4390, TROY, MI, 48099-4390, US

(21) Appl. No.: 11/716,309

(22) Filed: Mar. 9, 2007

Related U.S. Application Data
(60) Provisional application No. 60/781,513, filed on Mar. 10, 2006.

(51) Int. Cl. E05B 37/02

(52) U.S. Cl. 70/312

(57) ABSTRACT

An adjustable lock assembly that can be used with a sliding window or a sliding door to limit the complete opening of, brace completely shut, or both. The lock assembly can include a first body slidably telescoped with a second body. An affixation device affixes the length of the lock assembly to a selected length. A cuff is disposed around a connection joint defined between the first and second bodies.

### CROSS-REFERENCE TO RELATED APPLICATION

This application claims the priority of co-pending U.S. Provisional Application No. 60/781,513 filed Mar. 10, 2006.

### TECHNICAL FIELD

The field of this invention relates generally to lock assemblies that limit the opening of, or securely close sliding windows and sliding doors.

### BACKGROUND OF THE DISCLOSURE

Sliding windows and sliding doors are commonly framed in walls of residential and travel homes between a fully closed position and a fully open position. Sliding windows usually slide either horizontally or vertically, while sliding doors usually only slide horizontally. Oftentimes, it is desirable to brace such sliding windows and sliding doors fully closed, or to limit their opening to form a partially open condition with a gap between the windows and doors and the respective frame. What is needed is a locking assembly that limits the opening of either a sliding window or sliding door and that can be easily stowed.

### SUMMARY OF THE DISCLOSURE

One embodiment of a lock assembly used with a sliding window or a sliding door may have first and second elongated bodies slideably connected together for adjusting the length of the lock assembly. The first elongate body may have a proximal end hinged to a frame of the sliding window or the sliding door. The lock assembly may also have an affixation device for affixing the length of the lock assembly to a selective length and a cuff disposed around the first elongate body that, when tightened, affixes the connection between the first and second bodies defined at the cuff. The lock assembly may further have a clip constructed to be mounted to a frame of the sliding window or the sliding door.

Another embodiment of a lock assembly for bracing a sliding window or a sliding door close may have a first body with a proximal end and a threaded distal end, and may have a second body telescoped and adjustable in the first body. The second body has an opening with a pin assembly partly disposed inside of the second body and with a pin resiliently biased through the opening by a spring. The lock assembly may further include a threaded cuff fastened around the first body that, when tightened, strengthens a connection joint defined thereat, and may include a stop located on the second body. The stop is constructed to engage a portion of the sliding window or the sliding door.

Yet another embodiment of a lock assembly for limiting the opening of a vertical sliding window may include first and second elongated bodies slidably connected together for adjusting the length of the lock assembly with the first elongated body having a proximal end pivotably hinged to an upper ledge of the vertical sliding window for pivotal movement between a stowed position that extends along the upper ledge and an engagement position that is substantially transverse to the upper ledge. The lock assembly may also include an affixation device for affixing the length of the lock assembly to a selected length to allow an adjustable limited opening of the vertical sliding window until an end of the lock assembly abuts a ledge of the vertical sliding window.

### BRIEF DESCRIPTION OF THE DRAWINGS

Reference now is made to the accompanying drawings in which:

FIG. 1 shows one embodiment of a lock assembly installed on a vertically sliding window;

FIG. 2 is a sectional view of the lock assembly taken along line 2-2 in FIG. 1;

FIG. 3 is a perspective view of the lock assembly of FIG. 1;

FIG. 4 is an exploded view of the lock assembly of FIG. 1;

FIG. 5 is a sectional view of the lock assembly taken along line 4-4 in FIG. 3; and

FIG. 6 is a partial perspective view of another embodiment of a lock assembly.

### DETAILED DESCRIPTION OF THE PREFERRED EMBODIMENT

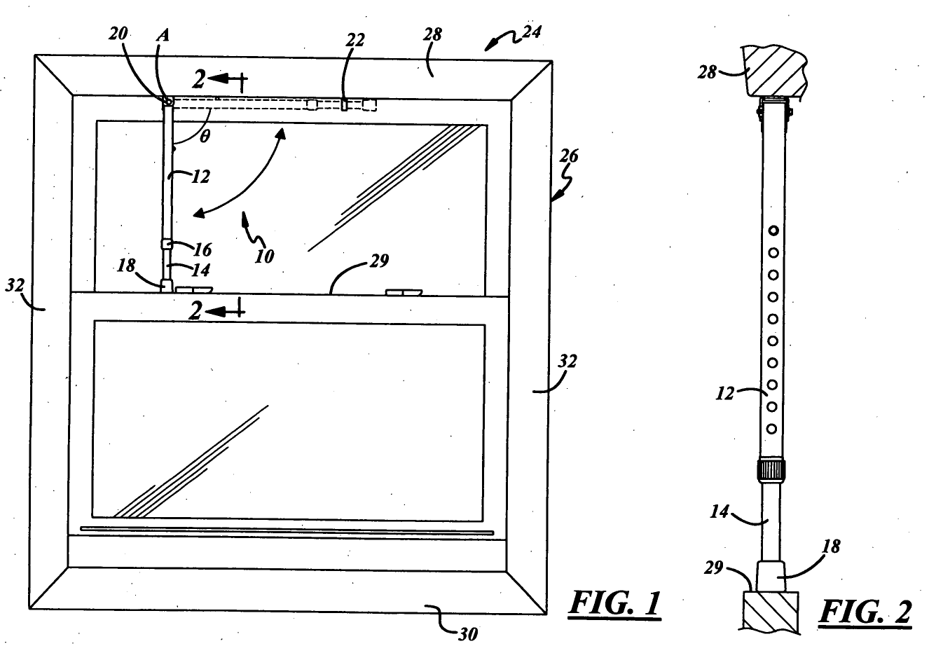

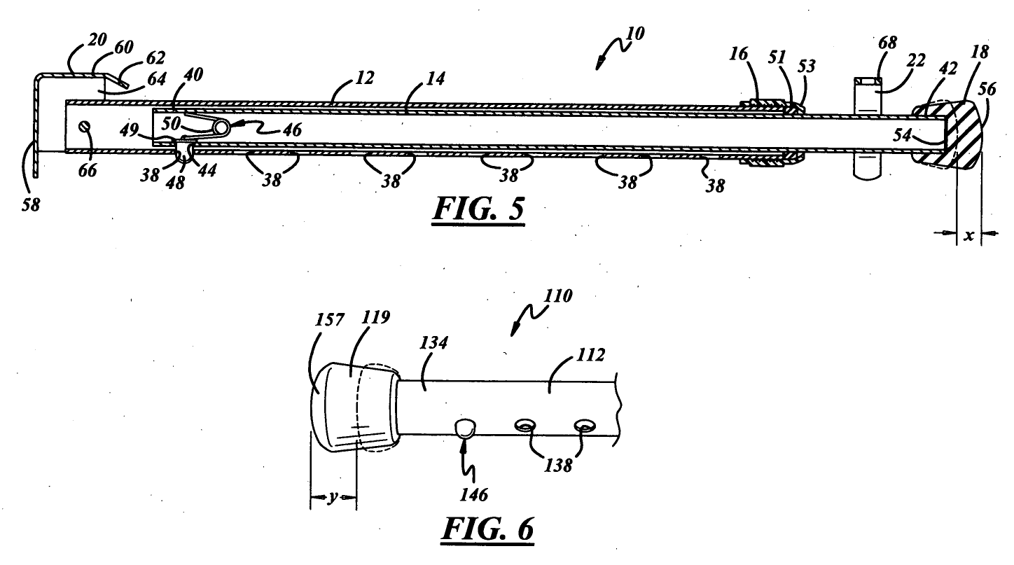

Referring now to the drawings, FIGS. 1-6 show two embodiments of a lock assembly 10 that can limit the opening of, or securely close a sliding window (e.g., horizontal or vertical) or a sliding door (e.g., patio door). Such windows and doors are common in residential homes, but can also be found in commercial structures, and the like. In general, the lock assembly 10 can be retrofitted on an existing sliding window or door, or can be integrated as part of an original installation of the sliding window or door. As shown, both embodiments comprise a first body 12 telescoped with a second body 14 such that the second body slides within the first body to adjust the length of the lock assembly 10. A cuff 16 can be disposed around both the first and second bodies 12, 14 to enhance a joint connection between the two, and a deformable stop 18 can be located to at least an end of the second body 14 to press against a ledge 29 of the sliding window or the sliding door when the lock assembly 10 is engaged.

In the embodiment shown in FIGS. 1-5, the lock assembly 10 can be installed in various ways on a sliding window or a sliding door such that it pivots about a point A to define a range of motion Θ between a stowed position and an engagement position, which in this case is 90°. When assembled, the lock assembly 10 has a linear adjustable length on a line B (FIG. 2) preferably between 14 and 35 inches. As shown in FIG. 1, the lock assembly 10 is retrofitted with a bracket assembly 20 and a clip 22 to a vertical window 24, particularly to a frame 26 and an upper frame member 28 or upper ledge of the vertical window. The lock assembly 10 can be an integral part of the frame 26, in which case the bracket and the clip can be a part of the upper frame member 28 or not be provided at all. And of course the lock assembly 10 can be installed on a lower frame member 30 of the vertical window 24, or in the case of a horizontal window, to a side frame member 32. In the case of a sliding door (not shown), the lock assembly 10 could be installed to an edge of the door itself or to a frame of a door.

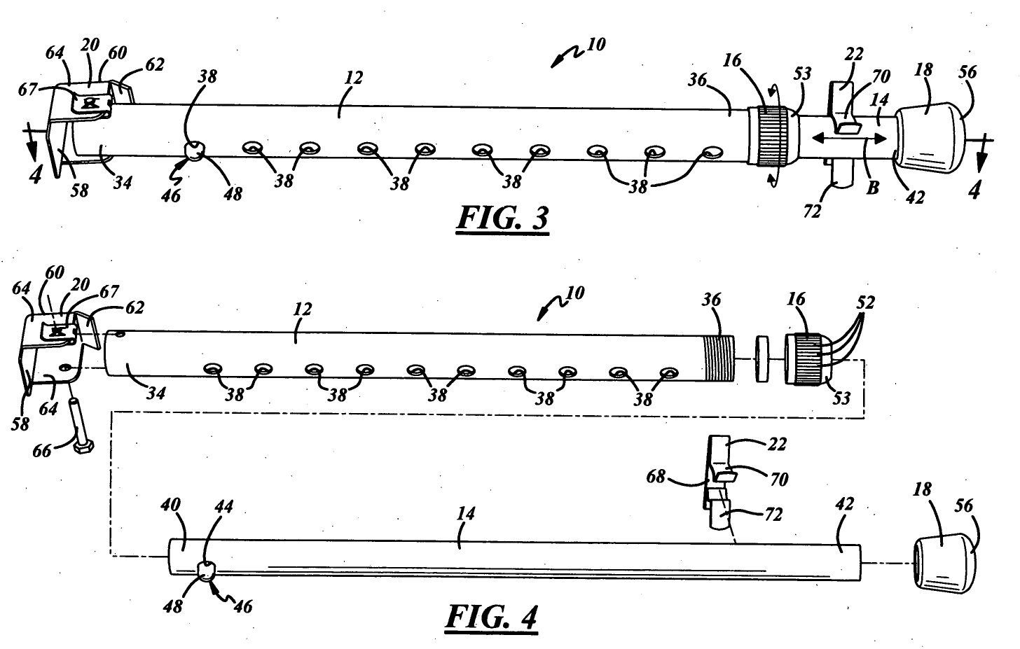

The first body 12 is hinged to the frame to provide a swinging motion through angle Θ about pivot axis A. The first body 12 carries the second body 14 to provide a linear adjustment along line B. As shown, the first body 12 has a tubular shape, for example with a ⅞ inch outer diameter, but other shapes are possible, and it can be made out of a hard material including aluminum, steel, structural plastic, and the like. Referring to FIGS. 3-5, the first body 12 extends between a proximal end 34 and a partly threaded distal end 36, and defines a plurality of holes 38 therebetween that are linearly aligned and spaced apart by 1 inch. Each hole 38 constitutes an increment in extension or retraction, depending on the direction along line B for the lock assembly 10. The holes 38 can be of different numbers and different spacings.

The second body 14 adjustably retracts and extends telescopically through the first body 12 and is affixed at adjusted positions. The second body 14 has a complementary shape that is reduced in size, in this case a tubular shape with a ¾ inch outer diameter. Like the first body 12, the second body 14 can be made out of a hard material including aluminum, steel, structural plastic, and the like. The second body 14 has a first end 40 slidably extending within the first body 12 and a second distal end 42 protruding out of the distal end 36 of the first body. An affixation device can be provided for locking the second body 14 in place with respect to the first body 12. For example, a single opening 44 is defined in the second body 14 to receive part of a protruding pin assembly 46. The pin assembly 46 provides stepwise fixable adjustment of the lock assembly 10 as the second body 14 slides in the first body 12. In particular, a pin 48 is resiliently biased and protrudes through the opening 44 by a spring 50. The pin 48 is sized to fit in each of the holes 38 and has a flange 49 that anchors the pin in the second body 14. The spring 50 is located inside of the second body 14 and can be various types including, as shown, a torsion spring, a compression spring, and the like. The spring 50 has one end fixed to the pin 48 and its other end fixed to the inner surface of the second body 14. Once the pin 48 extends through the opening 44 and one of the holes 38, the second body 14 is locked in place with the first body 12.

The cuff 16 serves several functions for the lock assembly 10 including, when tightened, constricting slack between the first and second bodies, serving as an additional affixation on the adjustment, and adding strength to a connection joint defined at the cuff between the bodies. The first and second bodies 12, 14 can have a bit of slack, or looseness, between them because of their relative sizes; and the joint can be a vulnerable point to stresses emitted to the lock assembly 10. The cuff 16 is threaded to twist clockwise for tightening, and twist counterclockwise for loosening. As shown most clearly in FIGS. 3 and 4, the cuff 16 has a cylindrical shape and can be made out of a hard material including aluminum, steel, structured plastic, and the like. The cuff 16 is disposed around the first body 12 and the second body 14 to define the connection joint at the distal end 36 where it can be fastened to the first body 12. A rubber gasket 51 can be positioned beneath the cuff 16 and at the joint so the cuff has a tighter fit around the bodies. The cuff 16 also has a peripheral lip 53 that hugs against an outer surface of the second body 14 and that, when tightened, exerts an axial force to the gasket 51 which, in turn, exerts an axial force to the first body 12. When tightened, the cuff 16 exerts a radial force at the joint to, as mentioned, constrict, affix, and strengthen the joint. When loosened, the exerted radial force is removed and the second body 14 can freely slide in the first body 12. A plurality of ribs 52 are notched in an outer surface of the cuff 16 and stretch axially therealong for enhancing manual gripping when tightening and loosening the cuff.

The stop 18 contacts and presses the ledge 29 of the vertical window 24 when the lock assembly 10 is in the engagement position. The stop 18 has a generally cone-shape and can be made out of a solid thermoplastic such as polyethylene, or another resilient material that is compressible. The stop 18 encases the second end 42 of the second body 14 in a cavity 54. The cavity 54 can be pressed over the second end 42, can incorporate optional ribs (not shown), can be glued, and the like. An arcuate contact surface 56 actually abuts the ledge 29 of the vertical window 24. As noted, the stop 18 is compressible a small distance X which, in some embodiments, can equal a full increment between successive holes 38 so that when the vertical window 24 is completely shut, the lock assembly 10 can be pressed tight against the vertical window with the stop 18 compressed thus emitting a force against the vertical window and bracing it close. The stop 18 may have a non-slip property to further enhance engagement with the ledge 29.

The bracket assembly 20 mounts to the upper frame member 28 and pivotally hinges the lock assembly 10 thereto. The bracket assembly 20 can be made out of a hard material such as aluminum, steel, structural plastic and the like. It can be screwed to the upper frame member 28 through a mount wall 58 which defines one or more screw holes. A bottom wall 60 extends from the mount wall 58 and has a lip 62 projecting at about a 33° angle from the bottom wall 60. When in the engagement position, the stop 18 engages the ledge 29 and the lip 62 holds the first body 12 at a 90° angle with the edge of the vertical window 24. A pin or bolt 66 goes through the first body 12 and through both sides of sidewalls 64 to provide the pivot A. The pin 66 can be held in place by a speed nut 67. Skilled artisans will appreciate various ways of mounting the lock assembly 10 to provide the pivot A other than the bracket assembly 20.

The clip 22 mounts to the upper frame member 28 opposite the bracket assembly 20 to catch and retain a section of the second body 14 to put the lock assembly 10 in the stowed position. As shown, the clip 22 is of the U-clip type, but other types of clips can be used. The clip 22 has a base 68 defining a screw-hole for a screw to mount the clip to the upper frame member 28. A pair of flexible arms 70, 72 accepts and retains the second body 14 when the lock assembly 10 is press-fitted in the clip 22. The clip 22 can also be sized to accept the first body 12 and thus can be positioned as such along the upper frame member 28.

In use, the lock assembly 10 is first installed in the vertical window 24. The bracket assembly 20 is bolted to the upper ledge of the upper frame member 28 in a position where the first and second bodies 12, 14 can swing about pivot A along angle Θ without interruption or otherwise bumping into the side frame member 32 when the lock assembly 10 is fully extended to the 35 inches. The clip 22 is also screwed to the upper frame member 28 horizontally away from the bracket assembly 20 where the clip is positioned to catch the second body 14. Installed in this way, the lock assembly 10 is oriented perpendicular to the window sliding direction when in the stowed position, i.e., retained by the clip 22, and is oriented parallel to the window sliding direction when in the engagement position as shown in FIG. 1. In the case of a horizontally sliding window or sliding door, the same holds true for the lock assembly 10 mounted to a side frame member.

Once installed, the lock assembly 10 is ready for use. When in the engagement position, the lock assembly 10 can be equipped to brace the vertical window 24 shut, or to limit the complete opening of the window. To do so, the pin assembly 46 can be actuated by pressing the pin 48 against the spring 50 to retract the pin within the opening 44 and thus within the second body 14. When the cuff 16 is loosened, the second body 14 can then slide through the first body 12 until the pin assembly 46 encounters the selective hole 38. The lock assembly 10 can stretch far enough to brace the vertical window 24 shut, or stretch a sufficient length to limit the complete opening and leave a gap in the vertical window as shown in FIG. 1. Once the lock assembly 10 is stretched to a desired length, the cuff 16 can be tightened to serve as an additional affixation on the assembly's adjustment, and to strengthen the joint at the distal end 36 and the underlying second body 14. Indeed, when the lock assembly 10 is clipped and in the stowed position, the vertical window 24 is free to slide fully open.

In the alternate embodiment shown in FIG. 6, a lock assembly 110 has some similarities with the previous embodiment of FIGS. 1-5. For example, although not shown, a second body with a pin assembly, a cuff, and a stop are all similar to the components as previously described.

The lock assembly 110 can be installed on a sliding window or a sliding door by being urged between a frame and a ledge of the sliding window or door. The lock assembly 110 is held in place partly by a linear force exerted by the lock assembly between the frame and the sliding window or door, and partly by friction created between the ends of the lock assembly and the frame and the ledge of the sliding window or door. The lock assembly 110 is preferably adjustable between 14 and 35 inches—whatever the particular sliding window or door calls for—to brace it completely close. A first body 112 has a tubular shape but other shapes are possible and it can be made out of a hard material such as aluminum, steel, structured plastic, and the like. The first body 112 extends between a proximal end 134 and a distal end, and defines a plurality of holes 138 therebetween that are linearly aligned and spaced apart by 1 inch. Each hole 138 constitutes an increment in extension or retraction, depending on the direction of adjustment for the lock assembly 110. The holes 138 could be of different numbers and different spacings.

In this embodiment a second stop 119 contacts either the frame or the ledge of the sliding window or door when the lock assembly 110 is engaged. The stop 119 is similar to the stop 18 as previously described. The second stop 119 has a generally cone-shape and can be made out of a solid thermoplastic such as polyethylene, or another resilient material that is compressible. The second stop 119 encases the proximal end 134 of the first body 112 in a cavity (not shown). The cavity can be press-fit over the proximal end 134 with the aid of optional ribs (not shown) that are lined along the cavity, the cavity can be glued, and the like. An arcuate contact surface 157 actually abuts the opposite edge. The stop 119 is compressible like the stop 18. In FIG. 6, the second stop 119 is compressible a small distance Y which can be equal to the previously described distance X and emits a similar force.

Variations and modifications are possible without departing from the scope and spirit of the present invention as defined by the appended claims.

1. A lock assembly to limit the opening of or to securely close a sliding window or a sliding door, the lock assembly comprising:
first and second elongated bodies slideably connected together for adjusting the length of the lock assembly, said first elongate body having a proximal end hinged to a frame of the sliding window or the sliding door;
an affixation device for affixing the length of the lock assembly to a selective length;
a cuff disposed around said first elongate body that, when tightened, affixes the connection between said first and second bodies defined at said cuff; and
a clip constructed to be mounted to the frame of the sliding window or the sliding door, wherein the lock assembly pivots between an engagement position where the lock assembly provides for a selective amount of opening for the sliding window or the sliding door, to a stowed position where the lock assembly is retained by said clip.

2. A lock assembly as defined in claim 1 further comprising a bracket assembly constructed to be mounted to the frame of the sliding window or the sliding door, said bracket assembly hinged to said proximal end of said first elongate body and permitting an approximate 90° range of swinging motion of the lock assembly between said engagement position and said stowed position.

3. A lock assembly as defined in claim 1 further comprising said first elongate body being a tube with a diameter sized to slideably receive said second elongate body, said second elongate body also being a tube with a diameter, both diameters being sized to provide sliding engagement between the two bodies.

4. A lock assembly as defined in claim 2 further comprising said first elongate body having a distal end and defining a plurality of holes lined between said proximal and distal ends.

5. A lock assembly as defined in claim 1 further comprising said second elongate body defining an opening and having a pin protruding and biased through said opening by a spring positioned in said second elongate body.

6. A lock assembly as defined in claim 5 further comprising said spring positioned in said second elongate body being a torsion spring with one end fixed to said pin and another end fixed to an inner surface of said second elongate body.

7. A lock assembly as defined in claim 1 further comprising a stop positioned on an end of said second elongate body and constructed to engage a portion of the sliding window or the sliding door.

8. A lock assembly as defined in claim 7 further comprising said stop being composed of a polyethylene material, said stop surrounding an end of said second elongate body and compressible a distance that is greater than half the distance separating successive holes defined in said first elongate body.

9. A lock assembly as defined in claim 1 further comprising said cuff having a peripheral lip that, when tightened, exerts an axial force to a gasket lying beneath said cuff.

10. A lock assembly as defined in claim 1 further comprising said clip being a U-clip that catches and retains a portion of said second elongate body when the lock assembly is in said stowed position.

11. A lock assembly as defined in claim 1 further comprising when in said stowed position, the lock assembly being generally parallel with and seated against an upper frame member of the sliding window, and when in said engagement position, the lock assembly being generally perpendicular to said upper frame member.

12. A lock assembly for bracing a sliding window or a sliding door close, the lock assembly comprising:
a first body having a proximal end and a threaded distal end, said first body having a tubular shape and defining a plurality of holes linearly aligned between said proximal and distal ends;
a second body telescoped and adjustable in said first body, said second body having a first end located inside of said first body and a second end located outside of said first body, said second body defining an opening;
a pin assembly partly disposed inside of said second body and adjacent said first end, and having a pin biased through said opening of said second body by a spring;
a threaded cuff fastened around said distal end of said first body that, when tightened, strengthens a connection joint defined at said distal end with said underlying first body; and
a stop located on said second end of said second body, said stop constructed to engage a portion of the sliding window or the sliding door.

13. A lock assembly as defined in claim 12 further comprising a second stop located on said proximal end of said first body, said second stop constructed to engage a portion of the sliding window or the sliding door.

14. A lock assembly as defined in claim 13 wherein said stop and said second stop are composed of a polyethylene material and each encase their respective ends in a respective cavity, and each further include an arcuate contact surface constructed to engage a portion of the sliding window or the sliding door.

15. A lock assembly as defined in claim 12 further comprising a bracket assembly hinged to said proximal end of said first body and being constructed to mount the lock assembly to the sliding window or the sliding door.

16. A lock assembly as defined in claim 15 further comprising a U-clip with a pair of projecting flexible arms to receive and retain said second body, said U-clip having a base to mount said U-clip to the sliding window or the sliding door.

17. A lock assembly as defined in claim 12 wherein said cuff has a peripheral lip that, when tightened, exerts an axial force to a gasket lying beneath said cuff which, in turn, exerts an axial force to said first body to thus strengthen the connection joint defined thereat.

18. A lock assembly for limiting the opening of a vertical sliding window, the lock assembly comprising:
first and second elongated bodies slidably connected together for adjusting the length of the lock assembly, said first elongate body having a proximal end pivotably hinged to an upper ledge of the vertical sliding window for pivotal movement between a stowed position that extends along said upper ledge and an engagement position that is substantially transverse to said upper ledge; and
an affixation device for affixing the length of the lock assembly to a selected length to allow an adjustable limited opening of the vertical sliding window until an end of the lock assembly abuts a ledge of the vertical sliding window.

19. A lock assembly as defined in claim 18 further comprising a clip constructed to be mounted to said upper ledge of the vertical sliding window, said clip retaining the lock assembly in said stowed position.

20. A lock assembly as defined in claim 18 further comprising a cuff disposed around said first elongate body that, when tightened, affixes the connection between said first and second bodies defined at said cuff.
